(19) United States
(12) Patent Application Publication
(10) Pub. No.: US 2010/0310732 A1
(43) Pub. Date: Dec. 9, 2010

(54) PRESSURE PACKAGED DOUGH PRODUCTS

(76) Inventors: David J. Domingues, Plymouth, MN (US); David A. Kirk, Coon Rapids, MN (US); Scott Kackman, New Hope, MN (US); Susan Hall, New Hope, MN (US)

Correspondence Address: GENERAL MILLS, INC., P.O. BOX 1113, MINNEAPOLIS, MN, 55440, US

(21) Appl. No.: 12/481,109

(22) Filed: Jun. 9, 2009

(51) Int. Cl. A21D 10/02; B65B 29/00

(52) U.S. Cl. 426/128; 426/410

(57) ABSTRACT

A pliable, sealed package made from one or more flexible films is used to store an uncooked dough product, with the dough product proofing within the sealed package so as to establish and maintain a greater than ambient pressure within the sealed package. In accordance with an aspect of the invention, the overall package is produced utilizing a horizontal form, fill and seal system. The sealed package can be shrunk and/or wrapped to also provide an external force which is essentially transferred to static pressure with the package.

### FIELD OF THE INVENTION

The invention pertains to the art of packaging and, more specifically, to packaging of soft, deformable uncooked dough products under pressure within a package, i.e, an internal pressure within the package of greater than ambient pressure.

### BACKGROUND OF THE INVENTION

It is common to package a refrigerated dough product in a canister of a fixed volume formed from composite paperboard which is spirally wound into a cylinder, with the refrigerated dough product being further proofed in the canister. In one known system, a dough manufacturing system is used to cut hexagonal shaped dough pieces, such as biscuits, from a sheet of dough and direct the dough pieces into respective canisters traveling below the dough manufacturing system. This overall process can be used to effectively stack multiple dough pieces, such as 8-10 biscuits, in a single, substantially continuously indexed container at a high rate. A generally similar process has also been performed for rolled dough products. However, packaging products in cardboard is actually, relatively expensive and, at least in connection with products having a small profit margin, can be cost prohibitive.

Mainly because of cost efficiencies and packaging versatility, vertical and horizontal form, fill and seal packaging systems have become increasingly popular, particularly in the food industry. For instance, vertical form, fill and seal systems have been used in connection with making sealed bags, such as potato chip and other types of snack bags, while horizontal form, fill and seal (HFFS) packaging systems have been known for use in effectively packaging frozen foods. By way of an example, a HFFS system can be employed to create product cavities or pouches in a lower film, with the pouches being filled with frozen dough products and sealed with an upper film. Prior to fully sealing the pouches, a vacuum is typically drawn in order to reduce the available headspace of the package. Although evacuating the headspace is appropriate for frozen dough products, employing a vacuum on a refrigerated dough product would inherently destroy nucleation sites for leavener in the dough and, consequently, the overall product.

Another problem with packaging dough in a flexible package, particularly refrigerated dough which has been pre-cut into products to be cooked, such as biscuits, concerns the use of the flexible package as the sole and primary package. Basically, the dough will deform in response to gravity and external pressure/weight applied to the dough. This could occur even in loaded shopping bags. Obviously, the deformation of the dough would undesirably result in inconsistently shaped cooked products. Although this problem could be solved by further packaging the flexible package in a carton or the like, this option would negate the cost savings.

Based on the above, it would be advantageous to enable both low and high pressure refrigerated dough products, particularly soft, deformable dough products, to be effectively stored and sold under pressure in flexible packaging, thereby minimizing any potential product deformation.

### SUMMARY OF THE INVENTION

In accordance with a product aspect of the invention, a soft, deformable uncooked dough product is stored in a flexible, non-expanding film-formed package under greater than ambient pressure. The dough can be either a low or high pressure dough, i.e., dough packaged at and above atmospheric pressure. Basically, a static pressure is created within the package by expansion of the dough after packaging. By increasing the internal pressure, the arrangement limits the extent that the package and product can be physically deformed, thereby enhancing the stability of the overall product. External pressure can also be applied, such as through the use of shrinkable film for the package or the application of an outer wrap, with the external pressure working to further establish and maintain the greater than ambient, internal pressure.

In accordance with a packaging method aspect of the invention, product receiving cavities are formed in a first film in a horizontal form, fill and seal system, one or more soft, deformable uncooked dough products are loaded in each cavity, the available headspace in the cavity is reduced, the cavity is sealed with a second film and the dough expands to increase the pressure within the internal cavity. The package can be made with a shrinkable film or a wrap can also be provided about the cavity to apply an external pressure.

Additional objects, features and advantages of the invention will become more readily apparent from the following detailed description when taken in conjunction with the drawings wherein like reference numerals refer to corresponding parts in the several views.

### BRIEF DESCRIPTION OF THE DRAWINGS

FIG. 1 schematically illustrates a horizontal form, fill and seal (HFFS) system constructed in accordance with the invention.

FIG. 2 is a perspective view of a packaged dough product prior to heat shrinking of the package in accordance with the invention.

FIG. 3 is a perspective view of the packaged dough product of FIG. 2 after heat shrinking.

FIG. 4 is a partially cut-away, perspective view of the packaged dough product of FIG. 2 with an outer wrap applied thereto.

### DETAILED DESCRIPTION OF EMBODIMENTS

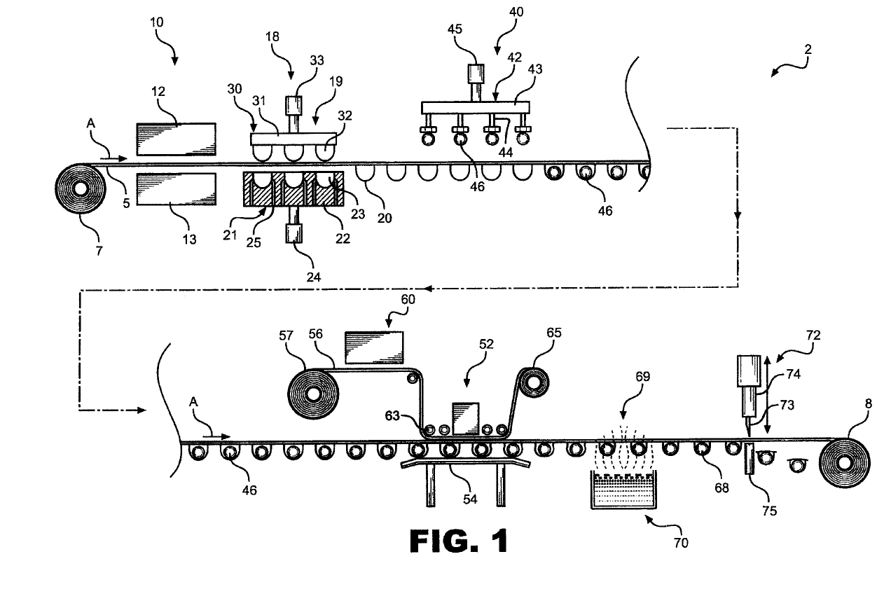

With initial reference to FIG. 1, a horizontal form, fill and seal (HFFS) system employed in connection with a packaging method of the present invention is generally indicated at 2. As shown, system 2 has associated therewith a first or lower, flexible or pliable film 5 which runs from a payout reel 7 in the direction of arrow A to a take-up reel 8. As will become more fully evident below, the majority of film 5 is used in connection with packaging uncooked dough products in accordance with the invention and take-up reel 8 receives the left over or scrap film. In a preferred form of the invention, take-up reel 8 merely receives lateral edge portions of lower film 5, such as an inch (approximately 2.54 cm) of either side of film 5 while the remainder of the film 5 is employed in the final package. In any case, lower film 5 is first directed to a heating station 10 and is directed between upper and lower heating units 12 and 13. In general, heating station 10 can employ various types of heater units 12, 13 known in the art, such as radiant, conduction and/or convection heaters. Basically, it is simply desired to heat lower film 5 for delivery to forming station 18. In forming station 18, a thermoforming unit 19 is employed to produce product cavities 20 in lower film 5. To this end, thermoforming unit 19 includes a lower cavity mold 21 having a main body 22 formed with recessed cavities 23. A linear actuator 24 is connected to main body 22 and designed to vertically shift main body 22 during the forming of product cavities 20. For use in connection with the forming process, fluid communication lines, such as that indicated at 25, extend through main body 22 to recessed cavities 23. In conjunction with lower cavity mold 21, thermoforming unit 19 includes an upper cavity mold 30 which also includes a main body 31 from which extend various projection molds 32 that conform to recessed cavities 23. In a manner similar to lower cavity mold 21, upper cavity mold 30 is connected to a linear actuator 33 used to vertically shift upper cavity mold 30 during a thermoforming operation.

In general, thermoforming devices such as that employed in connection with forming station 18 are widely known in the art and do not form part of the present invention. However, for the sake of completeness, it should at least be understood that the function of forming station 18 is to receive heated lower film 5 between lower cavity mold 21 and upper cavity mold 30 at which time the movement of lower film 5 is temporarily stopped, projection molds 32 are mated with recessed cavities 23 in order to reshape lower film 5 to include product cavities 20. To aid in this shaping operation, fluid communication lines 25 can be hooked to a vacuum source in order to draw lower film 5 against recessed cavities 23 as well as to subsequently apply a positive pressure to aid in removing the formed product cavities 20 from lower cavity mold 21 after the thermoforming process is complete.

Once product cavities 20 are formed in lower film 5, lower film 5 advances to a loading or filling station generally indicated at 40. At this point, it should be recognized that filling station 40 can take various forms without departing from the invention. As illustrated, filling station 40 includes a vertical loading unit 42 including a platform 43 from which extend various loading arms 44 used to transport products, such as that indicated at 46, into the individual product cavities 20. More specifically, as will be detailed more fully below, the invention is concerned with packaging uncooked dough products 46 within product cavities 20.

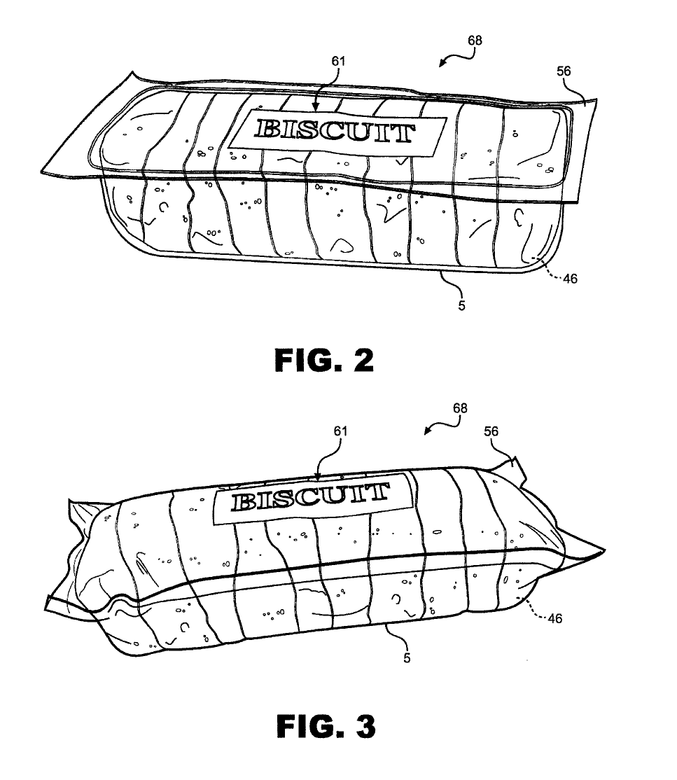

After products 46 are loaded into product cavities 20, lower film 5 is advanced to a sealing station 52. At or prior to sealing station 52, an external force is applied to lower film 5 in order to reduce package headspace volume associated with product cavities 20. The external force can be established in various ways, such as by providing either a fixed or movable plate, as indicated at 54, which abuts lower film 5. In another embodiment, a housing including a pressure chamber at sealing station 52 can be employed, such as disclosed in co-owned U.S. Patent Application entitled “HFFS Packaging Method Employing Positive Differential Pressure” filed on even date herewith and incorporated herein by reference. At sealing station 52, a second or upper, flexible film 56 is drawn from a payout reel 57 and can be delivered through a printing unit 60. When employed, printing unit 60 can be used to provide product information, advertising and similar indicia directly on upper film 56 as generally indicated at 61 in FIG. 2. After following various guide rollers 63 to sealing station 52, the remainder of upper film 56 is directed to a take-up reel 65. At sealing station 52, upper film 56 is sealed to lower film 5 across product cavities 20 in order to create an overall product package indicated at 68. Again, the sealing of films 5 and 56 is performed after a desired headspace volume reduction has been performed. Although not required in accordance with the invention, package 68 can be directed to a package shrinking station 69 having a heat source generally indicated at 70, which can take various forms including radiant, convection or conduction heat sources, employed to reduce the overall size of internal cavity 20, thereby minimizing internal space within package 68. Next, package 68 proceeds to a cutter station 72 wherein a blade element 73 is shifted vertically through the use of a linear actuator 74 against an anvil member 75 in order to cut each package 68 from the overall web defined by the mated lower film 5 and upper film 56. At this point, package 68 is ready to ship for sale to a consumer.

Important in accordance with the invention is that package 68 is completely sealed, films 5 and 56 are essentially non-expandable and product 46 is uniquely constituted by an uncooked dough product, such as a soft, deformable, refrigerated dough product which can be constituted by either a low or high pressure dough. FIG. 2 illustrates package 68 just after the packaging process is complete. However, when uncooked dough product 46, whether in the form of biscuits, rolled dough or the like, is packaged in this manner, the dough product 46 will begin to proof and thereby expand within package 68. Since package 68 cannot expand, the pressure inside package 68 will increase to above ambient pressure, generally to 3-8 psig. FIG. 3 illustrates the package 68 of FIG. 2 following a degree of expansion of dough product 46 therein. Although dough product 46 will continue to proof throughout its life cycle, the amount of proofing is not enough to require venting of package 68 and sealing of package 68 is not negatively affected, particularly with the removal of the headspace in accordance with the invention. When packaged under increased internal pressure as discussed above, the arrangement limits the extent that the package and product can be physically deformed, thereby enhancing the stability of the overall product.

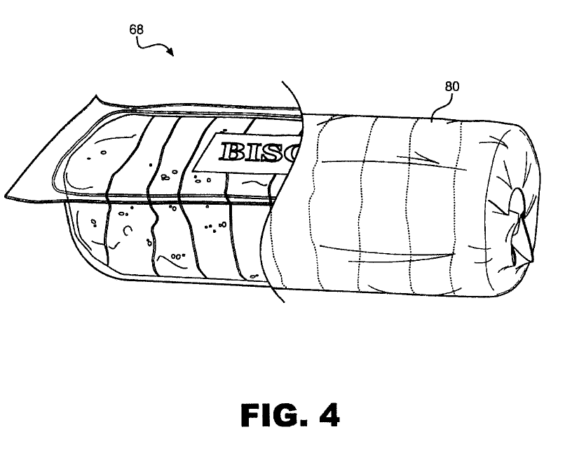

In further accordance with the invention, external pressure can also be applied, such as through the use of shrinkable film for package 68 or the application of an outer wrap, with the external pressure working to further establish and maintain the greater than ambient, internal pressure. Therefore, one or more of films 5 and 56 can be shrunk as discussed above at shrinking station 69. This shrinking alone can reconfigure package 68 from that shown in FIG. 2 to FIG. 3. In another embodiment, an external wrap, such as than partially shown at 80 in FIG. 4, is provided around package 68, such as immediately following cutter station 72. In either case, an external pressure can be effectively applied about package 68 which, in effect, additionally limits the extent that package 68 and product 46 can be physically deformed, thereby further enhancing the stability of the overall product. Basically, the applied compression force is essentially transferred to static pressure within the package 68.

Although described with reference to certain embodiments of the invention, it should be understood that various changes and/or modifications can be made to the invention without departing from the spirit thereof. For instance, although the referenced embodiment refers to a horizontal form, fill and seal system, other flexible packaging systems could be employed for the uncooked dough while providing for the increased internal packaging pressure. In any event, the invention is only intended to be limited by the scope of the following claims.

I/We claim:

1. A method of packaging an uncooked dough product comprising:
creating a flexible product receiving cavity in a first film;
loading an uncooked dough product in the product receiving cavity;
positioning a second film across the loaded product receiving cavity;
sealing the second film to the first film about the product receiving cavity to create a sealed package containing the uncooked dough product; and
increasing an internal pressure within the sealed package to greater than ambient pressure while the package is maintained sealed.

2. The method of claim 1, wherein the internal pressure is increased by proofing the uncooked dough product within the sealed package.

3. The method of claim 1, further comprising: reducing headspace within the product receiving cavity prior to sealing the second film to the first film.

4. The method of claim 1, wherein the uncooked dough product is constituted by either high or low pressure, soft, deformable and refrigerated dough.

5. The method of claim 1, wherein the packaging is performed with a horizontal form, fill and seal assembly.

6. The method of claim 1, wherein the internal pressure is in the range of 3-8 psig.

7. The method of claim 1, further comprising: providing and maintaining an external pressure on the sealed package.

8. The method of claim 7, wherein the external pressure is created by shrinking at least one of the first and second films.

9. The method of claim 7, wherein the external pressure is created by placing a wrap about the package.

10. A method of packaging an uncooked dough product comprising:
loading the uncooked dough product in a product receiving cavity formed from at least one flexible film;
sealing the product receiving cavity to create a sealed package containing the uncooked dough product; and
proofing the uncooked dough product within the sealed package, thereby increasing an internal pressure within the sealed package to greater than ambient pressure.

11. The method of claim 10, further comprising: reducing headspace within the product receiving cavity prior to sealing the second film to the first film.

12. The method of claim 10, wherein the uncooked dough product is constituted by either high or low pressure, soft, deformable and refrigerated dough.

13. The method of claim 10, wherein the packaging is performed with a horizontal form, fill and seal assembly.

14. The method of claim 10, further comprising: providing and maintaining an external pressure on the sealed package.

15. The method of claim 14, wherein the external pressure is created by shrinking at least one of the first and second films.

16. The method of claim 14, wherein the external pressure is created by placing a wrap about the package.

17. A sealed product package comprising:
a product receiving cavity formed from at least one flexible film; and
an uncooked dough product sealed within the product receiving cavity, said uncooked dough product being at least partially proofed within the sealed product package and a greater than ambient internal pressure exists within the package.

18. The sealed product package according to claim 17, wherein the uncooked dough product comprises either a low or high pressure, soft, deformable and refrigerated dough.

19. The sealed product package according to claim 17, wherein the at least one flexible film is heat shrinkable.

20. The sealed product package according to claim 17, further comprising: an external wrap extending around and providing an external force on the product receiving cavity.
